(19) United States
(12) Patent Application Publication
(10) Pub. No.: US 2004/0158663 A1
(43) Pub. Date: Aug. 12, 2004

(54) Interconnect topology for a scalable distributed computer system

(76) Inventor: Nir Peleg, Ha'anafa (IL)

Correspondence Address: SUGHRUE MION, PLLC, 2100 PENNSYLVANIA AVENUE, N.W., SUITE 800, WASHINGTON, DC, 20037, US

(21) Appl. No.: 10/451,071

(22) PCT Filed: Dec. 21, 2000
(86) PCT No.: PCT/US00/34258

(51) Int. Cl. G06F 13/00

(52) U.S. Cl. 710/100

(57) ABSTRACT

A computer network topology having a configuration with d dimensions and each processing node (211) is connected to the computer network topology through an inter-dimension switch. Each inter-dimension switch is connected to several intra-dimension switches (414), based on the number of dimensions of the computer network topology. Each intra-dimension switch (414) can be connected through a number of ports to a series of inter-dimension switches.

### BACKGROUND OF THE INVENTION

1. Technical Field of the Invention

This invention is related to an interconnection topology for a scalable distributed computer system. In particular, the invention relates the a mesh network using intra-dimensional and inter-dimensional switches to realize a scalable distributed computer system that can be rapidly enlarged while minimizing hardware impact.

2. Description of the Related Art

There will now be provided a discussion of various topics to provide a proper foundation for understanding the invention.

It has been a constant problem in the field of computers to improve the performance of computing systems. Pipelining and vector techniques, when applied to a single processor, greatly increased single processor performance. Parallel processors, when used in large-scale mainframe computers, have increased performance benchmarks as well.

However, two fundamental and interrelated problems are associated with parallel processing. First, the parallel processors must be interconnected such that the performance of the parallel processors is as close as possible to the number of processors times the performance of a single processor. Second, computations suitable for a single processor must be partitioned into a large number of computations that can be performed independently on distinct processors. Results obtained from each individual processor must be compiled to provide the identical computation that is achievable with a single processor. This computational sharing requires a significant amount of communication between the parallel processors. Typically, the time required for this inter-processor communication dominates the computational time and, as such, represents a significant roadblock improved parallel processor performance. Attempts to pipeline parallel processors showcase the fundamental multiprocessor problem of providing at least useful word per computing cycle to every processor in the parallel processor network.

For parallel processor configurations that have few processors, the crossbar switch provides the most effective inter processor communication. The crossbar switch provides a non-blocking network that interconnects inputs and outputs for all of the processors. Any one to one communication task is implemented with minimal blocking and with pipelining, so that one word can be provided to every processor on each communication cycle, using the crossbar switch. However, for a large number of processors, the crossbar switch becomes impractical because of the large number of wires and crosspoints that are required to implement this apparatus. In addition, there are some situations, e.g., multiple processors attempting to simultaneously communicate with a single processor, where blocking is unavoidable.

An alternative network commonly used for inter-processor communication is the hypercube. A hypercube contains far fewer crosspoints than the crossbar switch. However, the computation of the crosspoint switch settings for both the crossbar switch and the hypercube network is very time consuming since there are many communication tasks and computational tasks that must be implemented. Extensive work has been done in the prior art to address the issues of blocking and contention in hypercube networks and the use of routers that are based solely on source and destination addresses are common. However, any network and routing procedure that permits blocking can not be optimal and significantly degrades the computing performance of the multiprocessor.

Since the early 1980s, there have been several projects researching and developing new parallel computer architectures. Although these computers all involve the interconnection of many processors, the nature of the individual processors and how they are linked together vary greatly form design to design. Despite the vast number of proposed designs, it is possible to classify most parallel computers into a relatively small number of categories.

One broad categorization is made based on whether the individual processors carry out the same or different instruction streams. One design is labeled single instruction multiple data stream (SIMD) and refers to computers where a number of processing elements carry out the same instructions in lock step on parallel streams of data. SIMD machines are well suited for application such as numerical solution of differential equations where the identical numerical computation is carried out on each distinct grid point. The limitation of SIMI computers is that they can be used efficiently only when the computational problems well match the uniform structure of the machines.

The alternate category is the multiple instruction multiple data stream (MIMD) computers. MIM describes any linked collection of processing elements that are not constrained to carry out identical instruction streams (unlike SIX machines). To perform useful computation, the processors have to be able to communicate, and it is this communication scheme which defines the subcategories of MIMD computers.

The two most common communication strategies are for the processors to share a common pool of memory (shared memory) or to communicate explicitly by sending and receiving message packets (distributed memory). Many of the proposed and currently available MIMD computers use shared memory. In most shared memory computers, any processor can access any value in the common memory. This makes programming shared memory computers relatively straightforward, and for this reason, most research on automatic parallelizing compilers (i.e., compilers that convert serial programs to parallel) is targeting shared memory computers.

There is, however, a drawback to the shared memory architecture. As the number of processors becomes large, the communication with the shared memory can become a bottleneck. A possible way to avoid the limitation is to have a hierarchy of common memories wherein small clusters of processors share a common memory, and each cluster has a single channel to a global shared memory. Of course, the introduction of such a hierarchy is at the cost of programming simplicity that was the prime motivation for using the shared memory architecture.

Distributed memory architectures have the advantage that there are, in principle, no hardware bottlenecks since communication between one pair of processors and their memories is independent of communication between another pair of processors and their respective memories. The disadvantage of distributed memory systems is that programming is more difficult since passing data requires synchronizing both the sending and receiving processors.

An important design parameter of distributed memory computers is the connection topology of the processing elements—that is, the way in which the communication channels link the processors. Various communication topologies have been extensively studied. Typically, most communication topologies consist of regular grids in one or more dimensions (i.e., the grid's vertices represent processing elements and the edges represent communication channels). These studies have concluded that the computational problem at hand dictates the optimal processor connectivity. Hence, one option is to build a special purpose processor for each problem to be solved. A more practical alternative is to use complex processor connectivity incorporating a large number of useful sub-topologies.

An example of the second alternative is hypercube architecture. In a hypercube, the processor connectivity is that of an n-dimensional Boolean hypercube. A hypercube of dimension n has 2ⁿ processors each connected to n neighbors. This connection topology allows the embedding of regular meshes of lower dimension than the hypercube using a subset of the hypercube connections. Such mappings are easily carried out using a technique known as Gray coding.

Referring to FIG. 1A, a hypercube of dimension 1 is illustrated in conceptual form. Simply put, a hypercube of dimension 1 is comprises two processors positioned at network node location 1,2 linked together through a communications link 3. Referring to FIG. 1B, a hypercube of dimension 2 is illustrated in conceptual form. Each processor positioned at a network node location 47 of the hypercube is connected to two other processor located at other network node locations in the network through communications links 8a-8d Referring to FIG. 1C, a hypercube of dimension 3 is illustrated in conceptual form. The network of eight processors is configured in a cube, and each processor positioned at a network node location is connected to three of the other processor in the cube (reference characters are omitted for the sake of clarity) through communication links. Finally, referring to FIG. 1D, a hypercube of dimension 4 is illustrated in conceptual form. A dimension 4 hypercube has sixteen processors. Each of the processors in this hypercube is connected to four of the processors in the hypercube through (reference characters are omitted for the sake of clarity) communication links. The hypercube illustrated in FIG. 1D is one possible interconnect topology for a dimension 4 hypercube.

Interconnect topologies are often the cause for lack of scalability in distributed systems. It is desirable to have a topology that does not generate “hot spots.” This is possible by spreading interconnect loads evenly throughout the system. It is also desirable to maintain a quality of service that is independent of system size. Quality of service can be quantified by measuring the following system properties on a per-client basis:

Available bandwidth

Latency

Mean-Time-Between-Failure (MTBF)

Mean-Time-To-Repair (MBUR)

### SUMMARY OF THE INVENTION

The invention has been made in view of the above circumstances and to overcome the above problems and limitations of the prior art.

Additional aspects and advantages of the invention will be set forth in part in the description that follows and in part will be obvious from the description, or may be learned by practice of the invention. The aspects and advantages of the invention may be realized and attained by means of the instrumentalities and combinations particularly pointed out in the appended claims.

A fast aspect of the invention provides a fully populated computer network comprising a plurality of computer nodes (n) arranged in a mesh having a dimension (m). The computer network further comprises a plurality of inter-dimensional switches of width d, wherein width d represents the number of ports available on each inter-dimensional switch. Each occupied node is attached to one inter dimensional switch. The computer network further comprises a plurality of intra-dimensional switches of width w, wherein width w represents the number of ports available on each intra-dimensional switch. Each inter-dimensional switch is connected to one or more (d in the fully populated case) intra-dimensional switch. The number of nodes in the computer network is equal to w^{d}.

A second aspect of the invention provides a fully populated computer network comprising a plurality of computer nodes (n) arranged in a mesh having a dimension (m). The computer network further comprises a plurality of inter-dimensional switches of width d+1, wherein width d+1 represents the number of ports available on each inter-dimensional switch. Each occupied node is attached to a port of one inter-dimensional switch. The computer network further comprises a plurality of intra-dimensional switches of width w, wherein width w represents the number of ports available on each intra-dimensional switch. Each inter-dimensional switch is connected to one or more (d in the fully populated case) intra-dimensional switch. The number of nodes in the computer network is equal to w^{d}.

A third aspect of the invention provides a partially populated computer network comprising a plurality of computer nodes a plurality of nodes arranged in a mesh of dimension in, wherein m represents the maximum number of nodes connected to any one node of the plurality of nodes, and n represents the number of occupied nodes. The computer network further comprises a plurality of inter-dimensional switches of width d, wherein width d represents the number of ports available on each inter-dimensional switch. Each occupied node is attached to one inter-dimensional switch. The computer network further comprises a plurality of intra-dimensional switches, of width w, wherein width w represents the number of ports available on each intra-dimensional switch. Each intra-dimensional switch is connected to a port on at least one inter-dimensional switch. The number of occupied nodes n is less than w^{d}.

A fourth aspect of the invention provides a partially populated computer network comprising a plurality of nodes arranged in a mesh of dimension m, wherein m represents the maximum number of nodes connected to any one node of the plurality of nodes, and it represents the number of occupied nodes. The computer network further comprises a plurality of inter-dimensional switches of width d+1, wherein width d+1 represents the number of ports available on each inter-dimensional switch. Each occupied node is attached to a port of one inter dimensional switch. The computer network further comprises a plurality of intradimensional switches of width w, wherein width w represents the number of ports available on each intra-dimensional switch. Each intra-dimensional switch is connected to a port on at least one inter-dimensional switch. The number of occupied nodes it is less than w^{d}.

A fifth aspect of the invention provides a computer network comprising a plurality of nodes arranged in a mesh of dimension m, wherein m represents the maximum number of nodes connected to any one node of the plurality of nodes, and n represents the number of occupied nodes. The computer network further comprises a plurality of inter-dimensional switches of width d, wherein width d represents the number of ports available on each inter-dimensional switch and wherein each inter-dimensional switch has at least two occupied nodes attached thereto. The computer network further comprises a plurality of intra-dimensional switches of width w, wherein width w represents the number of ports available on each intra-dimensional switch. Each intra-dimensional switch is connected to a port on at least one inter-dimensional switch. The computer network may be partially or fully populated, such that the number of occupied nodes n is less than or equal to w^{d}.

A sixth aspect of the invention provides a computer network comprising a plurality of nodes arranged in a mesh of dimension m, wherein m represents the number of nodes connected to any one node of the plurality of nodes, and n represents the number of occupied nodes. The computer network further comprises a plurality of inter-dimensional switches of width d+1, wherein width d+1 represents the number of ports available on each inter dimensional switch. Each inter dimensional switch has at least two occupied nodes attached. The computer network further provides a plurality of intra-dimensional width w, wherein width w represents the number of ports available on each intra-dimensional switch. Each intra-dimensional switch is connected to a port on at least one inter-dimensional switch. The computer network may be partially or fully populated, such that the number of occupied nodes n is less than or equal to w^{d}.

A seventh aspect of the invention provides a computer network node that comprises at least one processor and an inter-dimensional network switch of width d, wherein width d represents the number of ports available on the inter-dimensional network switch connected to the at least one processor. The inter-dimensional switch transmits and receives data from at least one other computer network node, and the at least one other computer network node comprises a plurality of computer network nodes arranged in a mesh of dimension m, wherein m represents the number of computer network nodes connected to any one node of the plurality of nodes. The other computer network nodes are interconnected by plurality of intra-dimensional switches each with a width w. The computer network may be partially or fully populated, such that the number of computer network nodes is less than or equal to w^{d}.

An eighth aspect of the invention provides a computer network node that comprises at least one processor and an inter-dimensional network switch of width d+1, wherein width d+1 represents the number of ports available on the inter-dimensional network switch connected to at least one processor. The inter-dimensional switch transmits and receives data from at least one other computer network node, and at least one other computer network node comprises a plurality of computer network nodes arranged in a mesh of dimension m, connected to any one node of the plurality of nodes. The other computer network nodes are interconnected by plurality of intra dimensional switches each with a width w. The computer network may be partially or fully populated, such that the number of computer network nodes is less than or equal to w^{d}.

The above aspects and advantages of the invention will become apparent from the following detailed description and with reference to the accompanying drawing figures.

### BRIEF DESCRIPTION OF THE DRAWINGS

The accompanying drawings, which are incorporated in and constitute a part of this specification, illustrate the invention and, together with the written description, serve to explain the aspects, advantages and principles of the invention. In the drawings,

FIG. 1A illustrates a one-dimensional hypercube;

FIG. 1B illustrates a two-dimensional hypercube;

FIG. 1C illustrates a three-dimensional hypercube;

FIG. 1D illustrates a four-dimensional hypercube;

FIG. 2 illustrates a fully-populated network using an interconnect topology according to an aspect of the present invention;

FIGS. 3A-3C illustrate two dimensional perspective of the fully-populated network depicted in FIG. 2;

FIGS. 4A-4C illustrate another two dimensional perspective of the fully-populated network depicted in FIG. 2;

FIG. 5 illustrates a processor according to an aspect of the present invention with the network switch incorporated internally;

FIG. 6 illustrates a processor according to an aspect of the present invention with an external network switch;

FIG. 7 illustrates a processor comprised of several independent processors networked through a single external network switch;

FIG. 8 illustrates a processor comprised of several independent processors networked through a single inter-dimensional switch;

FIG. 9 illustrates a partially populated network according to an aspect of the invention;

FIGS. 10A-10C illustrates a plurality of independent processors connected to a minimum number of network switches; and

FIGS. 11A-D illustrates sharing a minimum number of network switches to realize an interconnection topology according to an aspect of the invention.

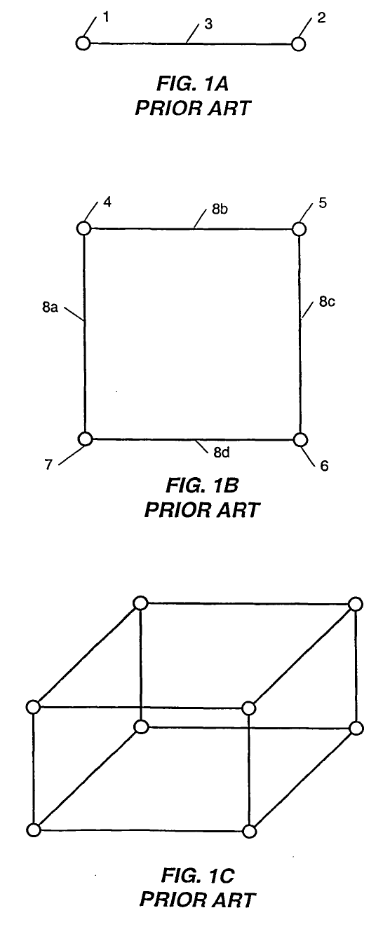

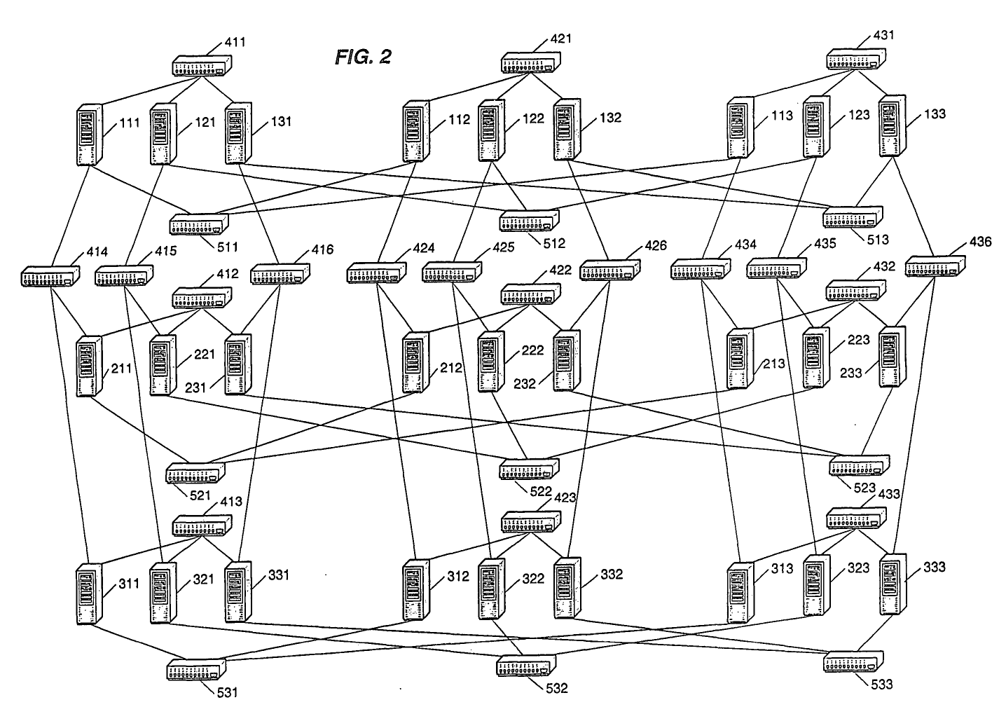

### DETAILED DESCRIPTION OF THE INVENTION

Prior to describing the aspects of the invention, some details concerning the prior art will be provided to facilitate the reader's understanding of the invention and to set forth the meaning of various tepms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the term “embedded computer system” includes, but is not limited to, an embedded central processor and memory bearing object code instructions. Examples of embedded computer systems include, but are not limited to, personal digital assistants, cellular phones and digital cameras. In general, any device or appliance that uses a central processor, no matter how primitive, to control its functions can be labeled has having an embedded computer system. The embedded central processor will execute one or more of the object code instructions that are stored on the memory. The embedded computer system can include cache memory, input/output devices and other peripherals.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

As used herein, the term “network switch” includes, but is not limited to, hubs, routers, ATM switches, multiplexers, communications hubs, bridge routers, repeater hubs, ATM routers, ISDN switches, workgroup switches, Ethernet switches, ATM/fast Ethernet switches and CDDI/FDDI concentrators, Piber Channel switches and hubs, InfiniBand Switches and Routers.

A detailed description of the aspects of the invention will now be given referring to the accompanying drawings.

Referring to FIG. 2, a fully populated computer network is illustrated according to an aspect of the present invention. Please note that the concepts of the present invention do not require the each dimension of the network to be fully populated. As shown in FIG. 8, a partially populated network can function as well using the concepts of the present invention. As used herein, the term “network node location” refers to a point in the network topology where a processor or a plurality of processors operating in a master/slave configuration would be connected to the network.

Referring to FIG. 2, a fully populated dimension 3 network topology according to an aspect of the present invention is illustrated. The network topology is comprised of a plurality of network switches and a plurality of independent processors. For this particular network topology, there are twenty-seven independent network node locations (111, 112, 113, 121, 122, 123, 131, 132, 133, 211, 212, 213, 221, 222, 223, 231, 232, 233, 311, 312, 313, 321, 322, 323, 331, 332, 333). Each network node location in the network is connected to three other network node locations. A plurality of inter-dimensional switches of width d=3 (not shown) and a plurality of intra-dimensional switches of width w=3 (411, 412, 413, 414, 415, 416, 421, 422, 423, 424, 425, 426, 431, 432, 433, 434, 435, 436, 511, 512, 513, 521, 522, 523, 531, 532, 533) interconnect the processors located at the network node locations. As used herein, the term “width” refers to the number of available ports on either an inter-dimensional switch or an intra-dimensional switch.

For the fully populated dimension 3 network, each processor located at a network node location is connected to three intra-dimensional switches. The inter-dimensional switch connected to the processor effects the connection to the intra-dimensional switch. For example, consider the processors located at network node location 111, network node location 121 and network node location 131. These processors are connected to an intra-dimensional switch 411. The processor at network node location 111 is also connected to processors located at network node location 211 and at network node location 311 through another intra-dimensional switch 414. Finally, the processor located at network node location 111 is connected to the processor at network node location 112 and the processor at network node location 113 through intra-dimensional switch 511. The processors at other network node locations in the network topology illustrated in FIG. 2 are similarly interconnected.

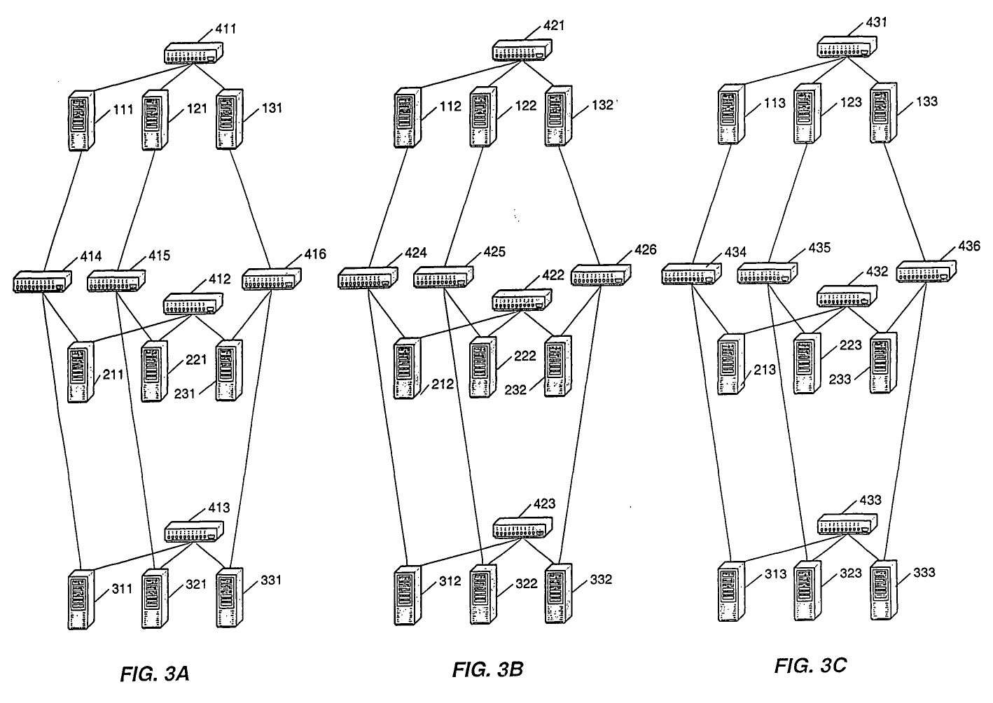

Referring to FIG. 3A, a portion of the fully populated dimension 3 network of FIG. 2 is illustrated. FIG. 3A depicts a 3×3 “dimensional section” of the fully populated dimension 3 network. For this exemplary dimensional section, network node locations are shown arranged in two directions.

In the first direction of the dimensional section, the processors located at network node location 111, network node location 121 and network node location 131 are interconnected through intra-dimensional switch 411. In the next row of network node locations, the processors at network node location 211, network node location 221 and network node location 231 are interconnected through intra-dimensional switch 412. In the last row of network node locations, the processors located at network node location 311, network node location 321 and network node location 331 are interconnected through intra-dimensional switch 413. In this manner, one of the three required network node location connections for a fully populated dimension 3 network according to the present invention is accomplished. Of course, if the network was a fully populated dimension 5 network, the processor located at each network node location would be connected to five other processors located at other network node locations in the dimension 5 network. The dimension of the network topology is directly related to the maximum number of connections to each network node location.

In the second direction of the dimensional section, the processors located at network node location 111, network node location 211 and network node location 311 are interconnected through intra-dimensional switch 414. In the next column of the dimensional section, the processors located at network node location 121, network node location 221 and network node location 321 are interconnected through intradimensional switch 415. In the last column of network node locations, the processors at network node location 131, network node location 231 and network node location 331 are interconnected through intradimensional switch 416. In this manner, the second of the three required network node location connections for a fully populated dimension 3 network according to the present invention is accomplished. The same interconnection concepts apply to the dimensional slices illustrated in FIGS. 3B and 3C, and a description thereof is omitted.

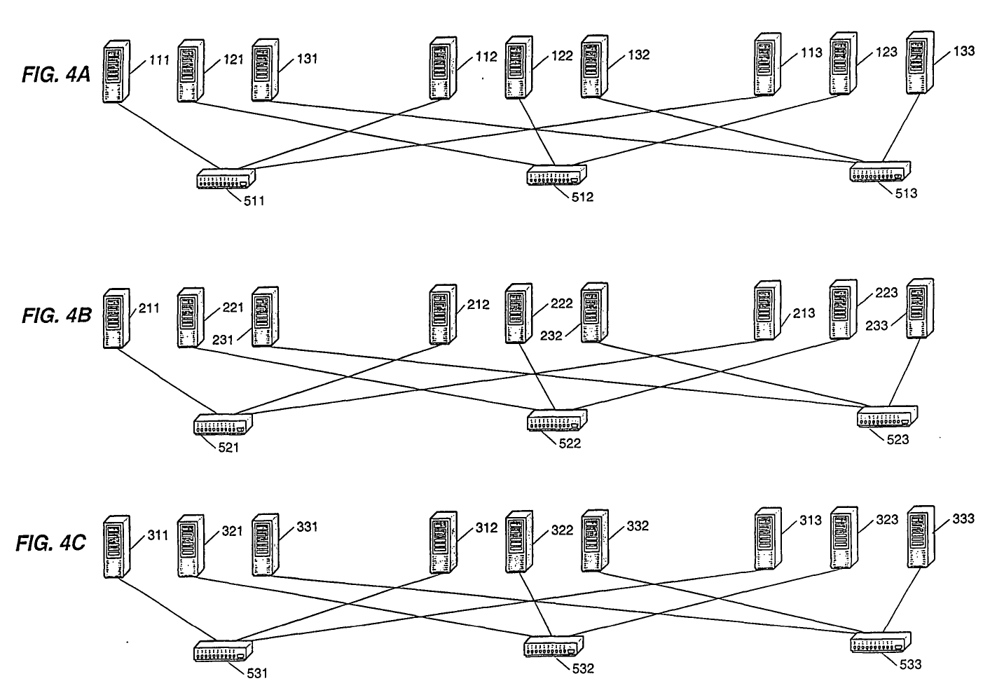

Referring to FIG. 4A, a portion of the fully populated dimension 3 network of FIG. 2 is illustrated. FIG. 4A depicts a 3×3 “cross dimensional section” of the fully populated dimension 3 network from a different perspective than FIG. 3A. For this exemplary dimensional section, network node locations are shown arranged in two directions.

In the first direction of this cross dimensional section, the processors located at network node location 111, network node location 112 and network node location 113 and interconnected by intra-dimensional switch 511. The next group of processors located at network node location 121, network node location 122 and network node location 123 are interconnected by intra-dimensional switch 512. The last group of processors located at the network node location 131, network node location 132 and network node location 133 are interconnected by intra-dimensional switch 513. In this cross dimensional section, there are no switches interconnecting the processors located at the network node locations in a cross-wise direction. The interconnection concepts apply equally to the cross dimensional sections illustrated in FIGS. 4B and 4C, and therefore the description thereof is omitted.

As discussed above, the width d refers to the number of available ports on an inter-dimensional switch. Similarly, the width w refers to the number of ports available on an intra-dimensional switch. The widths of the intra-dimensional switches and the width of the inter-dimensional switch can be used to determine the number of nodes in a given network topology. In a fully populated network topology, the total number of nodes n is given by Equation 1:

n=w^{d} Equation 1

The number of intra-dimensional switches p necessary to implement a fully populated network is given by Equation 2 or Equation 3:

$$p = ( \frac{dn}{w} ) \qquad Equation 2$$

p=dw^{d-1} Equation 3

As discussed below, an embodiment of the present invention uses inter-dimensional switches that are connected to the processor at the network node location through one of the ports that is available for connection to intra-dimensional switches. For example, an inter-dimensional switch may have twelve ports, but one of those ports is dedicated to the connection to the processor. Thus, the inter-dimensional switch only has eleven ports available for connection to intra-dimensional switches. The notation “d+1” refers to an inter-dimensional switch that is used in this manner.

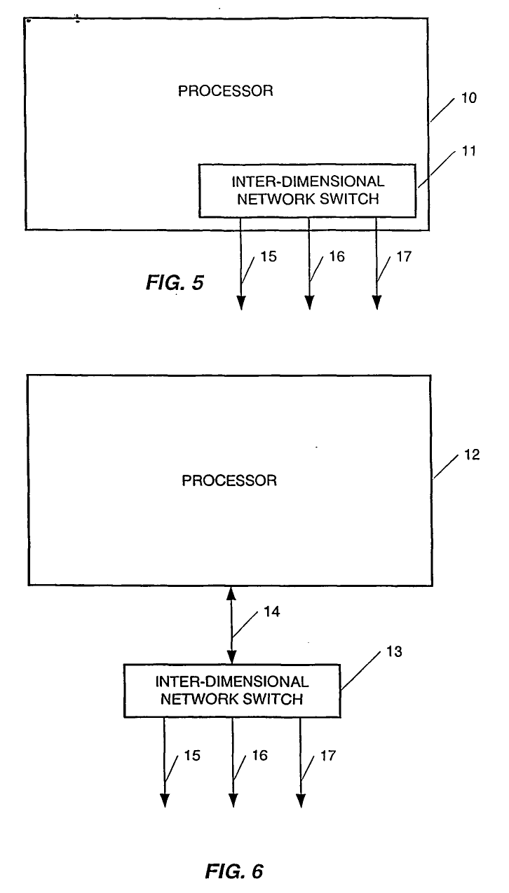

Referring to FIG. 5, a processor that is located at a network node location according to the present invention will now be discussed in greater detail. The processor 10 incorporates an inter-dimensional switch 11. The processor 10 can execute any one of several different operating systems. Of course, the processor 10 comprises storage devices with storage mediums for data caching (i.e., semiconductor memory) and data storage (not shown). In general, the storage devices are hard disk devices. Current hard disk devices, having storage capacities ranging in the gigabyte range, are well suited to the present invention. The storage device may also comprise a RAID device to allow for greater system availability. Other types of storage devices, such as optical drives, tape storage and semiconductor memory can be used as well.

Preferably, the inter-dimensional switch 11 incorporated in the processor 10 uses the InfiniBand protocol for data transmission and communication, but other bus protocols can be used as well. The inter-dimensional switch 11 has a plurality of ports such that the processor 10 can be connected to other network switches, and thereby be connected to other processor nodes according to the present invention. The ports of the inter-dimensional switch 11 are connected to other network switches via communication links 15-17, thereby connecting the processor 10 to other processors according to the present invention.

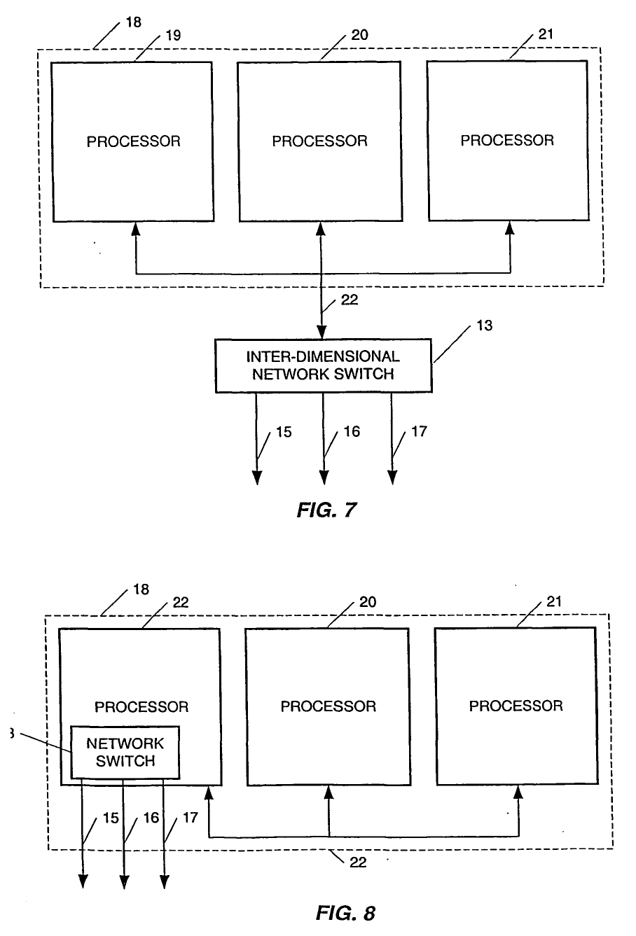

Referring to FIG. 6, another embodiment of a processor that is located at a network node location according to the present invention will now be discussed in greater detail. The processor 12 is connected to a port on the external network switch 13 via communications link 14. The processor 12 can execute any one of several different operating systems. Of course, the processor 12 comprises storage devices with storage mediums for data caching (i.e., semiconductor memory) and data storage (not shown). In general, the storage devices are hard disk devices. Current hard disk devices, having storage capacities ranging in the gigabyte range, are well suited to the present invention. The storage device may also comprise a RAID device to allow for greater system availability. Other types of storage devices, such as optical drives, tape storage and semiconductor memory can be used as well.

Preferably, the external network switch 13 uses the InfiniBand protocol for data transmission and communication to other network switches as well as to the processor 12, but other bus protocols can be used as well. The ports of the external network switch 13 are connected to other network switches via communication links 15-17, thereby connecting the processor 12 to other processors according to the present invention.

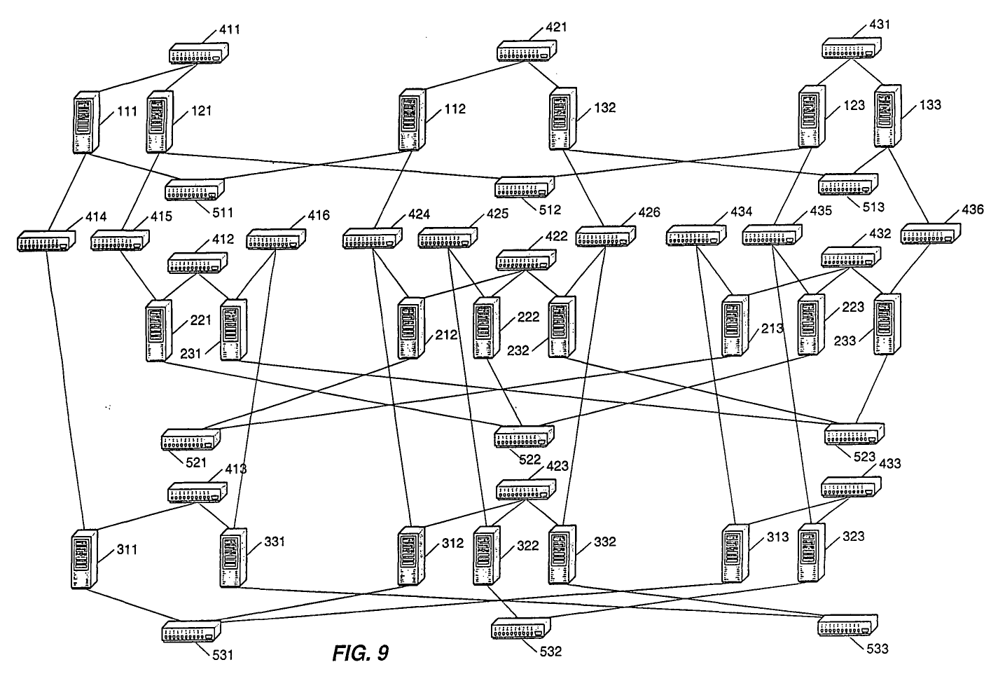

Referring to FIG. 7, another embodiment of a processor located at a network node location according to the present invention will now be discussed in greater detail. The processor node is connected to a port on the external network switch 13 via bus 22. The connection can also be link based as well. The processor 18 comprises multiple processors 19-21, and the processors 19-21 execute any one of several different operating systems. The multiple processors are interconnected via bus 22. Of course, the processor 18 comprises storage devices with storage mediums for data caching (i.e., semiconductor memory) and data storage (not shown). In general, the storage devices are hard disk devices. Current hard disk devices, having storage capacities ranging in the gigabyte range, are well suited to the present invention. The storage device may also comprise a RAID device to allow for greater system availability. Other types of storage devices, such as optical drives, tape storage and semiconductor memory can be used as well.

Although the processor 18 is comprised of multiple processors, to the outside world, it appears as one processor. Typically, one of the processors would be a master (19) and the remaining processors (20-21) would be slaves. Other types of multiple processor configurations would be acceptable substitutes as well. Preferably, the external network switch 13 uses the InfiniBand protocol for data transmission and communication to other network switches as well as to the processor 18, but other bus protocols can be used as well. The ports of the external network switch 13 are connected to other network switches via communication links 15-17, thereby connecting the processor 18 to other processors according to the present invention.

Referring to FIG. 8, another embodiment of a processor located at a network node location according to the present invention will now be discussed in greater detail. The processor 18 comprises multiple processors 19-21, and the processors 19-21 execute any one of several different operating systems, and one of the processors 23 incorporates an inter-dimensional switch 11. The multiple processors are interconnected via bus 22. Of course, the processor 18 comprises storage devices with storage mediums for data caching (i.e., semiconductor memory) and data storage (not shown). In general, the storage devices are hard disk devices. Current hard disk devices, having storage capacities ranging in the gigabyte range, are well suited to the present invention. The storage device may also comprise a RAID device to allow for greater system availability. Other types of storage devices, such as optical drives, tape storage and semiconductor memory can be used as well.

Although the processor 18 is comprised of multiple processors, to the outside world, it appears as one processor. Typically, one of the processors would be a master (22) and the remaining processors (20-21) would be slaves. Other types of multiple processor configurations would acceptable substitutes as well. Preferably, the inter-dimensional switch 13 uses the InfiniBand protocol for data transmission and communication to other network switches as well as to the processor 18, but other bus protocols can be used as well. The ports of the inter-dimensional switch 13 are connected to other network switches via communication links 15-17, thereby connecting the processor 18 to other processors according to the present invention.

FIG. 9 is similar to FIG. 2 in that a dimension 3 network topology is shown. Unlike the network topology illustrated in FIG. 2, all the available network node locations are not used. The interconnect topology of FIG. 9 still realizes all the advantages of the present invention, and is a more typical implementation of the invention for widespread networks. In comparing the fully populated network illustrated in FIG. 2 to the partially populated network illustrated in FIG. 9, the processors located at network node location 131, network node location 122, network node location 113, network node location 212, network node location 321 and network node location 333 are missing. Therefore, since these processors are not included in the network topology, the corresponding connections to the various intra-dimensional and intra-dimensional switches do not have to be realized. For example, since no processor is located at network node location 131, no connection to intra-dimensional switch 411 and intra-dimensional switch 416 is necessary, and a connection to intra-dimensional switch 513 is unnecessary as well. The same exercise is true for the other unpopulated network node locations. A partially populated network topology is illustrative of the scalability of the network topology according to the invention. A partially populated network can be constructed at a given instance in time, and if user demand requires increasing the processing power of the network, additional processors can occupy the unused network node locations without having to redesign the network topology.

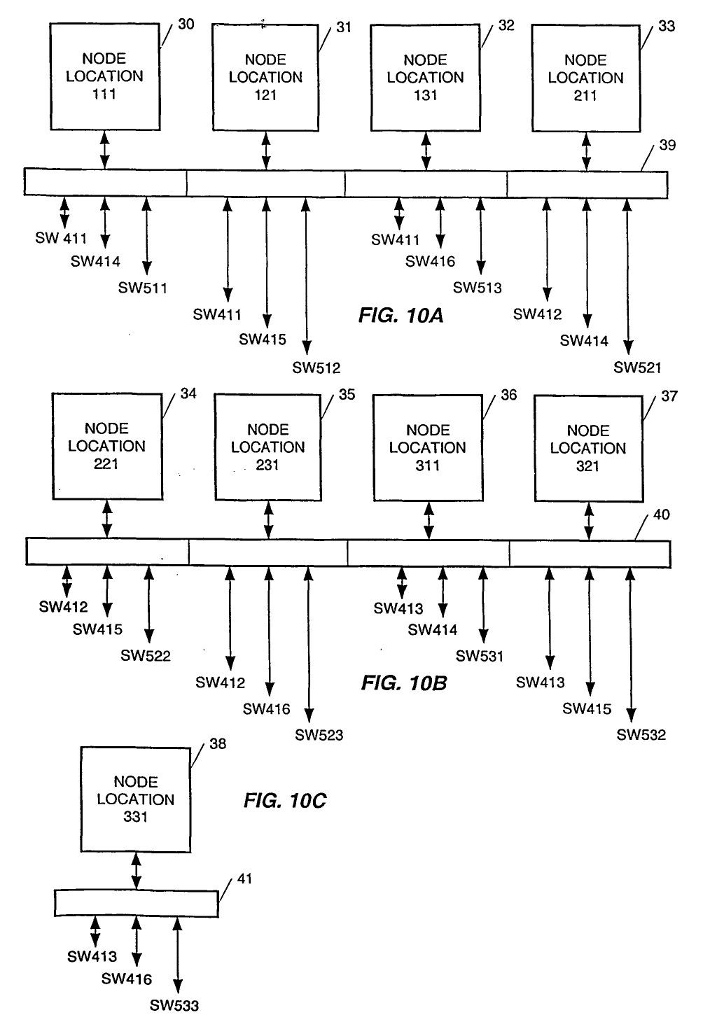

Referring to FIGS. 10A-C, another aspect of the invention is depicted. As described above, a processor will comprise an inter-dimensional network switch in order to interconnect with the other processors located at other network node locations. And as previously described, if an external inter-dimensional network switch is used, the processor connects to a port on the inter-dimensional network switch, and the other ports are used for interconnecting to the other processors. This is the d+1 configuration. If the network topology requires a large number of network switches, the cost can become great. However, the present invention provides for a single inter-dimensional switch that can provide networking services to multiple processors, thereby providing considerable savings in equipment costs.

In FIG. 10A, a portion of the fully populated network illustrated in FIG. 2 is shown in schematic format. In the embodiment illustrated, inter-dimensional network switch 38 provides interconnection services for processor 30 located at network node location 111, processor 31 located at network node location 121, processor 32 located at network node location 131 and processor 33 located at network node location 211. In this embodiment, the inter-dimensional network switch 38 has sixteen ports, and the inter-dimensional network switch 38 is divided into four sections of four ports each. For example, in the first section connected to processor 30, one port handles the connection between the network switch 38 and the processor 30. The remaining three ports are connected to intra-dimensional switch 411 (SW411), intra-dimensional switch 414 (SW414) and intra-dimensional switch 511 (SW511)(please see FIG. 2 for the network interconnect topology). This portion of the inter-dimensional switch is configured in the d+1 configuration (d=3), such that it has three ports available for connection to intra-dimensional switches. The processor 31 at network node location 121 utilizes a second section of inter-dimensional network switch 38, and the necessary connections are realized as shown in FIG. 2. FIGS. 10B-10C illustrate the other processors 32-38 are connected to the inter-dimensional network switches 3941 in similar fashion.

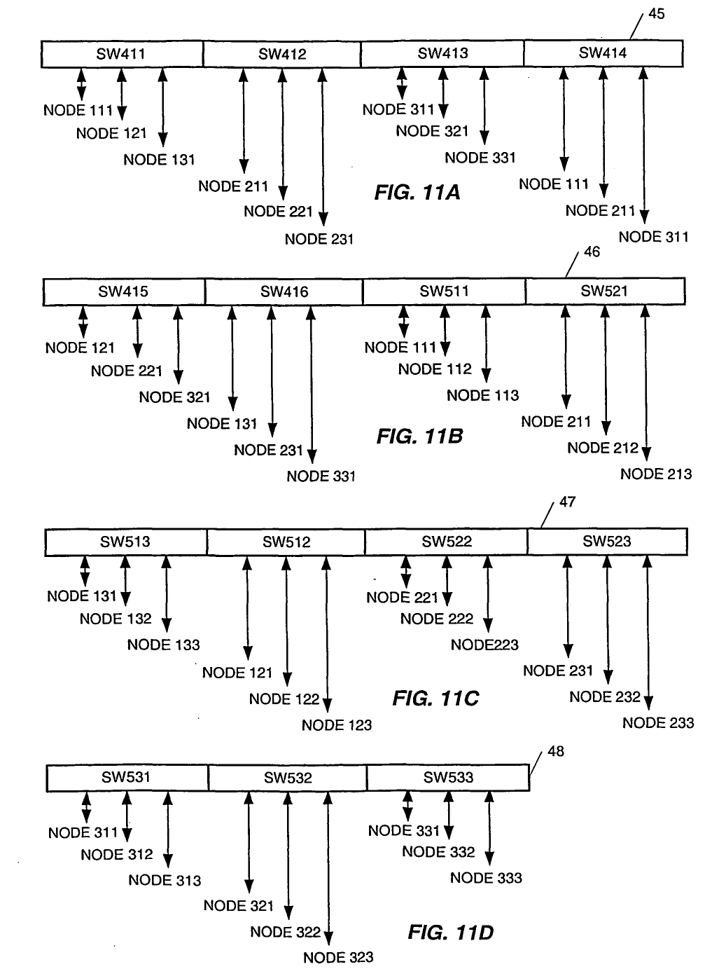

Referring to FIGS. 11A-11D, the concept of having a single network switch provide the interconnection support of several network switches is further illustrated as applied to the intra-dimensional switches. In FIGS. 11A and 11B, all the intradimensional switches required to realize the partial network shown in FIG. 3A are shown. In the embodiment illustrated, the intra-dimensional network switches 45, 46 are twelve port switches that have been divided into four sections. The first section SW411 acts as an intra-dimensional switch for the processors located at network node locations 111, 121 and 131. The second section SW412 acts as an intradimensional switch for the processors located at network node locations 211, 221, and 231. The third section SW413 acts as an intra-dimensional switch for the processors located at network node locations 311, 321, and 331. Finally, the fourth section SW414 acts as an intra-dimensional switch for the processors located at network node locations 111, 211, and 311. A second intra-dimensional network switch 46 realizes the intra-dimensional switches the remaining intra-dimensional switches (SW415 and SW416) for the partial network shown in FIG. 3A. Thus, two intra-dimensional network switches replace six separate intra-dimensional network switches using the port allocation of the present invention.

Referring to FIG. 11D, an intra-dimensional network switch 48 provides interconnection services for the partial network illustrated in FIG. 4C. The intra-dimensional network switch 48 is divided into three sections. The first section (SW531) provides interconnects the processors at network node locations 311, 312 and 313. The first section (SW532) interconnects the processors at network node locations 321, 322 and 323. The third section (SW533) interconnects the processors at network node locations 331, 332 and 333. Thus, a single intra-dimensional network switch replaces three intra-dimensional network switches using the port allocation of the present invention.

The foregoing description of the aspects of the invention has been presented for purposes of illustration and description. It is not intended to be exhaustive or to limit the invention to the precise form disclosed, and modifications and variations are possible in light of the above teachings or may be acquired from practice of the invention. The principles of the invention and its practical application were described in order to explain the to enable one skilled in the art to utilize the invention in various embodiments and with various modifications as are suited to the particular use contemplated.

Thus, while only certain aspects of the invention have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A computer network, comprising:
a plurality of nodes arranged in a mesh of dimension m, wherein m represents the number of nodes connected to any one node of the plurality of nodes, and n represents the number of occupied nodes;
a plurality of inter-dimensional switches of width d, wherein width d represents the number of ports available on each inter-dimensional switch and each occupied node is attached to one inter-dimensional switch; and
a plurality of intra-dimensional switches of width w, wherein width w represents the number of ports available on each intra-dimensional switch and each intra-dimensional switch is connected to a port on at least one inter-dimensional switch,
wherein the number of occupied nodes n is equal to w^{d}.

2. The computer network as claimed in claim 1, wherein the number of inter-dimensional switches connected to occupied nodes is equal to w^{d}.

3. The computer network as claimed in claim 1, wherein the number of intradimensional switches connected to the plurality of inter-dimensional switches is equal to
$$( \frac{dn}{w} ) .$$

4. The computer network as claimed in claim 1, wherein at least one of the intradimensional switches is a router.

5. The computer network as claimed in claim 1, wherein at least one of the intradimensional switches is a hub.

6. The computer network as claimed in claim 1, wherein at least one occupied node comprises an processor.

7. The computer network as claimed in claim 6, wherein at least one occupied node comprises a data storage device.

8. The computer network as claimed in claim 1, wherein at least one occupied node comprises an processor and a data storage device.

9. The computer network as claimed in claim 1, wherein at least one occupied node comprises a plurality of processors, wherein one of the plurality of processors is configured as master processor and the remaining processors are configured as slave processors.

10. A computer network, comprising:
a plurality of nodes arranged in a mesh of dimension m, wherein in represents the number of nodes connected to any one node of the plurality of nodes, and n represents the number of occupied nodes;
a plurality of inter-dimensional switches of width d+1, wherein width d+1 represents the number of ports available on each inter-dimensional switch and wherein each occupied node is attached to a port of one inter-dimensional switch; and
a plurality of intra-dimensional switches of width w, wherein width w represents the number of ports available on each intra-dimensional switch and each intra-dimensional switch is connected to a port on at least one inter-dimensional switch,
wherein the number of occupied nodes n is equal to w^{d}.

11. The computer network as claimed in claim 10, wherein the number of inter dimensional switches connected to occupied nodes is equal to w^{d}.

12. The computer network as claimed in claim 10, wherein the number of intra-dimensional switches connected to the plurality of inter-dimensional switches is equal to
$$( \frac{dn}{w} ) .$$

13. The computer network as claimed in claim 10, wherein at least one of the intra-dimensional switches is a router.

14. The computer network as claimed in claim 10, wherein at least one of the intra-dimensional switches is a hub.

15. The computer network as claimed in claim 10, wherein at least one occupied node is a processor.

16. The computer network as claimed in claim 15, wherein at least one occupied node comprises a data storage device.

17. The computer network as claimed in claim 10, wherein at least one occupied node comprises an processor and a data storage device.

18. The computer network as claimed in claim 10, wherein at least one occupied node comprises a plurality of processors, wherein one of the plurality of processors is configured as master processor and the remaining processors are configured as slave processors.

19. A computer network, comprising:
a plurality of nodes arranged in a mesh of dimension m, wherein m represents the maximum number of nodes connected to any one node of the plurality of nodes, and m represents the number of occupied nodes;
a plurality of inter-dimensional switches of width d, wherein width d represents the number of ports available on each inter-dimensional switch and each occupied node is attached to one inter-dimensional switch; and
a plurality of intra-dimensional switches, of width w, wherein width w represents the number of ports available on each intra-dimensional switch and each intra-dimensional switch is connected to a port on at least one inter-dimensional switch,
wherein the number of occupied nodes n is less than w^{d}.

20. The computer network as claimed in claim 19, wherein the number of inter-dimensional switches connected to occupied nodes is less than w^{d}.

21. The computer network as claimed in claim 19, wherein the number of intradimensional switches connected to occupied nodes is less than
$$( \frac{dn}{w} ) .$$

22. The computer network as claimed in claim 19, wherein at least one of the intra-dimensional switches is a router.

23. The computer network as claimed in claim 19, wherein at least one of the intra-dimensional switches is a hub.

24. The computer network as claimed in claim 19, wherein at least one occupied node comprises a processor.

25. The computer network as claimed in claim 24, wherein at least one occupied node comprises a data storage device.

26. The computer network as claimed in claim 19, wherein at least one occupied node comprises a processor and a data storage device.

27. The computer network as claimed in claim 19, wherein at least one occupied node comprises a plurality of processors, wherein one of the plurality of processors is configured as master processor and the remaining processors are configured as slave processors.

28. A computer network, comprising:
a plurality of nodes arranged in a mesh of dimension m, wherein m represents the maximum number of nodes connected to any one node of the plurality of nodes, and n represents the number of occupied nodes;
a plurality of inter-dimensional switches of width d+1, wherein width d+1 represents the number of ports available on each inter-dimensional switch and wherein each occupied node is attached to a port of one inter-dimensional switch; and
a plurality of intra-dimensional switches of width u, wherein width w represents the number of ports available on each intra-dimensional switch and each intra-dimensional switch is connected to a port on at least one inter-dimensional switch,
wherein the number of occupied nodes n is less than w^{d}.

29. The computer network as claimed in claim 28, wherein the number of inter-dimensional switches connected to occupied nodes is less than w^{d}.

30. The computer network as claimed in claim 28, wherein the number of intra-dimensional switches connected to occupied nodes is less than
$$( \frac{dn}{w} ) .$$

31. The computer network as claimed in claim 28, wherein at least one of the intra-dimensional switches is a router.

32. The computer network as claimed in claim 28, wherein at least one of the intra-dimensional switches is a hub.

33. The computer network as claimed in claim 28, wherein at least one occupied node is a processor.

34. The computer network as claimed in claim 33, wherein at least one occupied node comprises a data storage device.

35. The computer network as claimed in claim 28, wherein at least one occupied node comprises a processor and a data storage device.

36. The computer network as claimed in claim 28, wherein at least one occupied node comprises a plurality of processors, wherein one of the plurality of processors is configured as master processor and the remaining processors are configured as slave processors.

37. A computer network, comprising:
a plurality of nodes arranged in a mesh of dimension m, wherein m represents the maximum number of nodes connected to any one node of the plurality of nodes, and n represents the number of occupied nodes;
a plurality of inter-dimensional switches of width d, wherein width d represents the number of ports available on each inter-dimensional switch and wherein each inter-dimensional switch has at least two occupied nodes attached; and
a plurality of intra-dimensional switches of width w, wherein width w represents the number of ports available on each intra-dimensional switch and each intra-dimensional switch is connected to a port on at least one inter-dimensional switch,
wherein the number of occupied nodes n is less than or equal to w^{d}.

38. The computer network as claimed in claim 37, wherein the number of inter-dimensional switches connected to occupied nodes is less than w^{d}.

39. The computer network as claimed in claim 37, wherein the number of intra-dimensional switches connected to the plurality of inter-dimensional switches is less than or equal to
$$( \frac{dn}{w} ) .$$

40. A computer network, comprising:
a plurality of nodes arranged in a mesh of dimension m, wherein m represents the number of nodes connected to any one node of the plurality of nodes, and n represents the number of occupied nodes;
a plurality of inter dimensional switches of width d+1, wherein width d+1 represents the number of ports available on each inter-dimensional switch and wherein each inter-dimensional switch has at least two occupied nodes attached; and
a plurality of intradimensional width w, wherein width w represents the number of ports available on each intra-dimensional switch and each intra-dimensional switch is connected to a port on at least one inter-dimensional switch,
wherein the number of occupied nodes n is less than or equal to w^{d}.

41. The computer network as claimed in claim 40, wherein the number of inter-dimensional switches connected to occupied nodes is less than w^{d}.

42. The computer network as claimed in claim 40, wherein the number of intra dimensional switches connected to the plurality of inter-dimensional switches is less than or equal to
$$( \frac{dn}{w} ) .$$

43. A computer network node, comprising:
at least one processor,
an inter-dimensional network switch of width d, that transmits and receives data from at least one other computer network node, wherein width d represents the number of ports available on the inter-dimensional network switch connected to the at least one processor, wherein the at least one other computer network node comprises a plurality of computer network nodes arranged in a mesh of dimension m, wherein m represents the number of computer network nodes interconnected by plurality of intra-dimensional switches each with a width w, and wherein the number of computer network nodes is less than or equal to w^{d}.

44. The computer network node as claimed in claim 43, wherein the computer network node further comprises a plurality of processors, wherein one of the plurality of processors is configured as master processor and the remaining processors are configured as slave processors.

45. A computer network node, comprising:
at least one processor;
an inter-dimensional network switch of width d+1, that transmits and receives data from at least one other computer network node, wherein width d+1 represents the number of ports available on the inter-dimensional network-switch connected to the at least one processor, wherein the at least one other computer network node comprises a plurality of computer network nodes arranged in a mesh of dimension m, wherein in represents the number of computer network nodes interconnected by plurality of intra-dimensional switches each with a width w, and wherein the number of computer network nodes is less than or equal to w^{d}.

46. The computer network node as claimed in claim 45, wherein the computer network node further comprises a plurality of processors, wherein one of the plurality of processors is configured as master processor and the remaining processors are configured as slave processors.
